(19) United States
(12) Patent Application Publication
(10) Pub. No.: US 2024/0231465 A9
(43) Pub. Date: Jul. 11, 2024

(54) MULTI-CORE PROCESSOR FREQUENCY LIMIT DETERMINATION

(71) Applicant: Intel Corporation, Santa Clara, CA (US)

(72) Inventors: Yoav Babajani, Rishon Le Zion (IL); Hisham Abu Salah, Santa Clara, CA (US); Nadav Shulman, Tel Mond (IL); Nir Misgav, Ein Hahoresh (IL); Arik Gihon, Rishon Le Zion (IL)

(21) Appl. No.: 17/969,524

(22) Filed: Oct. 19, 2022

(51) Int. Cl. G06F 1/324; G06F 1/3206

(52) U.S. Cl. CPC G06F 1/324; G06F 1/3206

(57) ABSTRACT

Embodiments herein relate to a technique to be performed by a power control unit (PCU) of an electronic device. Specifically, the PCU may identify, based on a metric related to an activity level of a processor core of a multi-core processor of the electronic device, first, second, and third weights that are respectively related to first, second, and third cores of the multi-core processor. Based on these weights, the PCU may identify a number of active processor cores of the multi-core processor, and alter a frequency limit of the multi-core processor accordingly. Other embodiments may be described and claimed.

### FIELD

The present application generally relates to the field of electronic circuits and, more specifically, to multi-core processor frequency limit determination and associated apparatuses, systems, and methods.

### BACKGROUND

Multi-core processors may include a plurality of processor cores that may act at least partially independently of one another. Specifically, the different processor cores may be in different power states (e.g., Advanced Configuration and Power Interface (ACPI) C-States, or some other type of power state), operating at different frequencies from one another, operating at different voltage levels from one another, etc.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a smart device or a computer system or a System-on-Chip (SoC) with apparatus and/or software for determining the frequency limit of a multi-core processor, in accordance with some embodiments.

FIG. 2 depicts an example of interaction between a power control unit (PCU) and a multi-core processor of an electronic device, in accordance with various embodiments.

FIG. 3 illustrates an example technique related to determination of a frequency limit of a multi-core processor, in accordance with various embodiments.

### DETAILED DESCRIPTION

As previously noted, a multi-core processor may include a plurality of processor cores that may run independently from one another with respect to power consumption, power states, frequencies, etc. However, the overall function of the processor may be constrained by a frequency limit in accordance with table 1, below.

TABLE 1

| Number of Active Cores | Frequency Limit [in Gigahertz (GHz)] |
|---|---|
| 1 | 5.5 |
| 2 | 5.3 |
| 3 | 5.1 |
| 4 | 4.9 |
| 5 | 4.7 |
| 6 | 4.5 |
| 7 | 4.3 |
| 8 | 4.1 |

In legacy multi-core processors, the number of active cores may have been identified based on the respective power states of different cores. As used herein, the term “power state” refers to the C-state of a core as previously described. For example, if a core was in a C0 or C1 state, the core may have been designated as “active.” If a core was in a state other than the C0 or C1 state, the core may have been designated as “inactive.”

However, a core in a C0 or C1 state may have a relatively low level of activity from the standpoint of power consumed or operating frequency. As such, the processor core may negatively affect operation of the multi-core processor by causing the multi-core processor to operate at a lower voltage, frequency, or temperature than it would have otherwise. Additionally, changing the frequency limit of the processor based on a core toggling from one C-state to another may result in excessive toggling of the frequency limit of the processor.

Embodiments herein may remedy one or more of the above-described limitations of legacy frequency limit control of a multi-core processor. Specifically, embodiments relate to identifying activity of a core based on one or more additional/alternative factors to the C-state of the core. Such additional/alternative factors may include a frequency of the core, power consumption of the core (e.g., the voltage at which the core is operating), the temperature of the core, etc. Based on the factor(s) used, each core may be assigned a weight that contributes to the calculation of the overall activity level of the multi-core processor. Based on the calculated overall activity, a frequency limit of the multi-core processor may be identified.

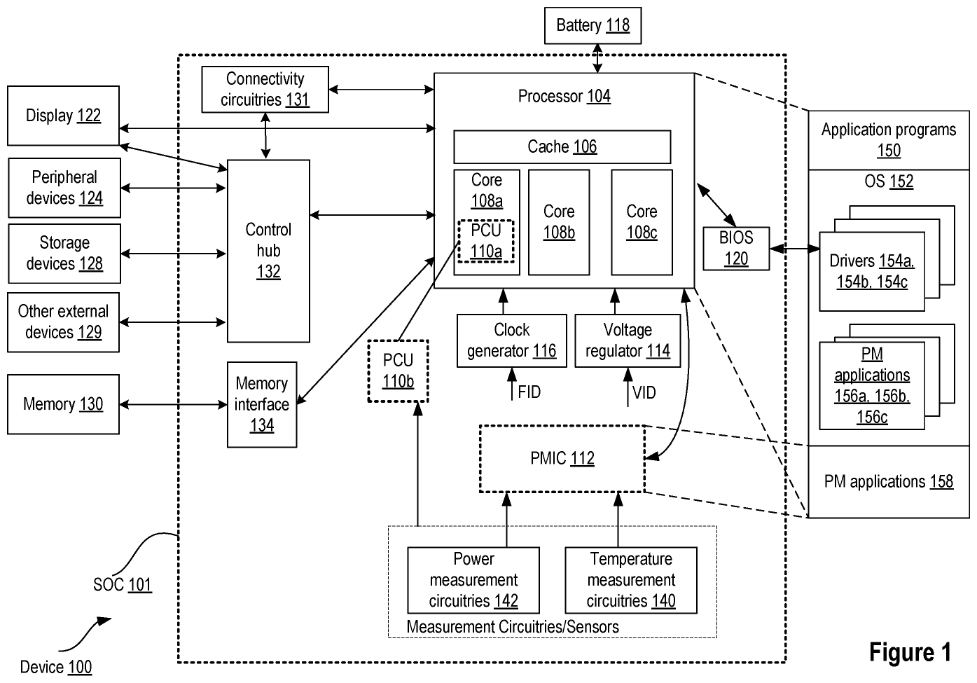

FIG. 1 illustrates a smart device or a computer system or a System-on-Chip (SoC) with apparatus and/or software to determine a frequency limit of a core of a multi-core processor of the system or device, in accordance with some embodiments.

In some embodiments, device 100 represents an appropriate computing device, such as a computing tablet, a mobile phone or smart-phone, a laptop, a desktop, an Internet-of-Things (IOT) device, a server, a wearable device, a set-top box, a wireless-enabled e-reader, or the like. It will be understood that certain components are shown generally, and not all components of such a device are shown in device 100. The apparatus and/or software for controlling wake sources in a system to reduce power consumption in sleep state can be in the wireless connectivity circuitries 131, PCU 110, and/or other logic blocks (e.g., operating system 152) that can manage power for the computer system.

In an example, the device 100 comprises an SoC (System-on-Chip) 101. An example boundary of the SoC 101 is illustrated using dotted lines in FIG. 1, with some example components being illustrated to be included within SoC 101—however, SoC 101 may include any appropriate components of device 100.

In some embodiments, device 100 includes processor 104. Processor 104 can include one or more physical devices, such as microprocessors, application processors, microcontrollers, programmable logic devices, processing cores, or other processing means. The processing operations performed by processor 104 include the execution of an operating platform or operating system on which applications and/or device functions are executed. The processing operations include operations related to I/O (input/output) with a human user or with other devices, operations related to power management, operations related to connecting computing device 100 to another device, and/or the like. The processing operations may also include operations related to audio I/O and/or display I/O.

In some embodiments, processor 104 includes multiple processing cores (also referred to as cores) 108a, 108b, 108c. Although merely three cores 108a, 108b, 108c are illustrated in FIG. 1, processor 104 may include any other appropriate number of processing cores, e.g., tens, or even hundreds of processing cores. Processor cores 108a, 108b, 108c may be implemented on a single integrated circuit (IC) chip. Moreover, the chip may include one or more shared and/or private caches, buses or interconnections, graphics and/or memory controllers, or other components.

In some embodiments, processor 104 includes cache 106. In an example, sections of cache 106 may be dedicated to individual cores 108 (e.g., a first section of cache 106 dedicated to core 108a, a second section of cache 106 dedicated to core 108b, and so on). In an example, one or more sections of cache 106 may be shared among two or more of cores 108. Cache 106 may be split in different levels, e.g., level 1 (L1) cache, level 2 (L2) cache, level 3 (L3) cache, etc.

In some embodiments, processor core 104 may include a fetch unit to fetch instructions (including instructions with conditional branches) for execution by the core 104. The instructions may be fetched from any storage devices such as the memory 130. Processor core 104 may also include a decode unit to decode the fetched instruction. For example, the decode unit may decode the fetched instruction into a plurality of micro-operations. Processor core 104 may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, execution unit may execute instructions out-of-order. Hence, processor core 104 may be an out-of-order processor core in one embodiment. Processor core 104 may also include a retirement unit. The retirement unit may retire executed instructions after they are committed. In an embodiment, retirement of the executed instructions may result in processor state being committed from the execution of the instructions, physical registers used by the instructions being de-allocated, etc. Processor core 104 may also include a bus unit to enable communication between components of processor core 104 and other components via one or more buses. Processor core 104 may also include one or more registers to store data accessed by various components of the core 104 (such as values related to assigned app priorities and/or sub-system states (modes) association.

In some embodiments, device 100 comprises connectivity circuitries 131. For example, connectivity circuitries 131 includes hardware devices (e.g., wireless and/or wired connectors and communication hardware) and/or software components (e.g., drivers, protocol stacks), e.g., to enable device 100 to communicate with external devices. Device 100 may be separate from the external devices, such as other computing devices, wireless access points or base stations, etc.

In an example, connectivity circuitries 131 may include multiple different types of connectivity. To generalize, the connectivity circuitries 131 may include cellular connectivity circuitries, wireless connectivity circuitries, etc. Cellular connectivity circuitries of connectivity circuitries 131 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 131 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 131 may include a network interface, such as a wired or wireless interface, e.g., so that a system embodiment may be incorporated into a wireless device, for example, a cell phone or personal digital assistant.

In some embodiments, device 100 comprises control hub 132, which represents hardware devices and/or software components related to interaction with one or more I/O devices. For example, processor 104 may communicate with one or more of display 122, one or more peripheral devices 124, storage devices 128, one or more other external devices 129, etc., via control hub 132. Control hub 132 may be a chipset, a Platform Control Hub (PCH), and/or the like.

For example, control hub 132 illustrates one or more connection points for additional devices that connect to device 100, e.g., through which a user might interact with the system. For example, devices (e.g., devices 129) that can be attached to device 100 include microphone devices, speaker or stereo systems, audio devices, video systems or other display devices, keyboard or keypad devices, or other I/O devices for use with specific applications such as card readers or other devices.

As mentioned above, control hub 132 can interact with audio devices, display 122, etc. For example, input through a microphone or other audio device can provide input or commands for one or more applications or functions of device 100. Additionally, audio output can be provided instead of, or in addition to display output. In another example, if display 122 includes a touch screen, display 122 also acts as an input device, which can be at least partially managed by control hub 132. There can also be additional buttons or switches on computing device 100 to provide I/O functions managed by control hub 132. In one embodiment, control hub 132 manages devices such as accelerometers, cameras, light sensors or other environmental sensors, or other hardware that can be included in device 100. The input can be part of direct user interaction, as well as providing environmental input to the system to influence its operations (such as filtering for noise, adjusting displays for brightness detection, applying a flash for a camera, or other features).

In some embodiments, control hub 132 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 122 represents hardware (e.g., display devices) and software (e.g., drivers) components that provide a visual and/or tactile display for a user to interact with device 100. Display 122 may include a display interface, a display screen, and/or hardware device used to provide a display to a user. In some embodiments, display 122 includes a touch screen (or touch pad) device that provides both output and input to a user. In an example, display 122 may communicate directly with the processor 104. Display 122 can be one or more of an internal display device, as in a mobile electronic device or a laptop device or an external display device attached via a display interface (e.g., DisplayPort, etc.). In one embodiment display 122 can be a head mounted display (HMD) such as a stereoscopic display device for use in virtual reality (VR) applications or augmented reality (AR) applications.

In some embodiments, and although not illustrated in the figure, in addition to (or instead of) processor 104, device 100 may include Graphics Processing Unit (GPU) comprising one or more graphics processing cores, which may control one or more aspects of displaying contents on display 122.

Control hub 132 (or platform controller hub) may include hardware interfaces and connectors, as well as software components (e.g., drivers, protocol stacks) to make peripheral connections, e.g., to peripheral devices 124.

It will be understood that device 100 could both be a peripheral device to other computing devices, as well as have peripheral devices connected to it. Device 100 may have a “docking” connector to connect to other computing devices for purposes such as managing (e.g., downloading and/or uploading, changing, synchronizing) content on device 100. Additionally, a docking connector can allow device 100 to connect to certain peripherals that allow computing device 100 to control content output, for example, to audiovisual or other systems.

In addition to a proprietary docking connector or other proprietary connection hardware, device 100 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 131 may be coupled to control hub 132, e.g., in addition to, or instead of, being coupled directly to the processor 104. In some embodiments, display 122 may be coupled to control hub 132, e.g., in addition to, or instead of, being coupled directly to processor 104.

In some embodiments, device 100 comprises memory 130 coupled to processor 104 via memory interface 134. Memory 130 includes memory devices for storing information in device 100.

In some embodiments, memory 130 includes apparatus to maintain stable clocking as described with reference to various embodiments. Memory can include nonvolatile (state does not change if power to the memory device is interrupted) and/or volatile (state is indeterminate if power to the memory device is interrupted) memory devices. Memory device 130 can be a dynamic random-access memory (DRAM) device, a static random-access memory (SRAM) device, flash memory device, phase-change memory device, or some other memory device having suitable performance to serve as process memory. In one embodiment, memory 130 can operate as system memory for device 100, to store data and instructions for use when the one or more processors 104 executes an application or process. Memory 130 can store application data, user data, music, photos, documents, or other data, as well as system data (whether long-term or temporary) related to the execution of the applications and functions of device 100.

Elements of various embodiments and examples are also provided as a machine-readable medium (e.g., memory 130) for storing the computer-executable instructions (e.g., instructions to implement any other processes discussed herein). The machine-readable medium (e.g., memory 130) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 100 comprises temperature measurement circuitries 140, e.g., for measuring temperature of various components of device 100. In an example, temperature measurement circuitries 140 may be embedded, or coupled or attached to various components, whose temperature are to be measured and monitored. For example, temperature measurement circuitries 140 may measure temperature of (or within) one or more of cores 108a, 108b, 108c, voltage regulator 114, memory 130, a mother-board of SoC 101, and/or any appropriate component of device 100.

In some embodiments, device 100 comprises power measurement circuitries 142, e.g., for measuring power consumed by one or more components of the device 100. In an example, in addition to, or instead of, measuring power, the power measurement circuitries 142 may measure voltage and/or current. In an example, the power measurement circuitries 142 may be embedded, or coupled or attached to various components, whose power, voltage, and/or current consumption are to be measured and monitored. For example, power measurement circuitries 142 may measure power, current and/or voltage supplied by one or more voltage regulators 114, power supplied to SoC 101, power supplied to device 100, power consumed by processor 104 (or any other component) of device 100, etc.

In some embodiments, device 100 comprises one or more voltage regulator circuitries, generally referred to as voltage regulator (VR) 114. VR 114 generates signals at appropriate voltage levels, which may be supplied to operate any appropriate components of the device 100. Merely as an example, VR 114 is illustrated to be supplying signals to processor 104 of device 100. In some embodiments, VR 114 receives one or more Voltage Identification (VID) signals, and generates the voltage signal at an appropriate level, based on the VID signals. Various type of VRs may be utilized for the VR 114. For example, VR 114 may include a “buck” VR, “boost” VR, a combination of buck and boost VRs, low dropout (LDO) regulators, switching DC-DC regulators, constant-on-time controller-based DC-DC regulator, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR, which is controlled by PCU 110a/b and/or PMIC 112. In some embodiments, each core has a network of distributed LDOs to provide efficient control for power management. The LDOs can be digital, analog, or a combination of digital or analog LDOs. In some embodiments, VR 114 includes current tracking apparatus to measure current through power supply rail(s).

In some embodiments, device 100 comprises one or more clock generator circuitries, generally referred to as clock generator 116. Clock generator 116 generates clock signals at appropriate frequency levels, which may be supplied to any appropriate components of device 100. Merely as an example, clock generator 116 is illustrated to be supplying clock signals to processor 104 of device 100. In some embodiments, clock generator 116 receives one or more Frequency Identification (FID) signals, and generates the clock signals at an appropriate frequency, based on the FID signals.

In some embodiments, device 100 comprises battery 118 supplying power to various components of device 100. Merely as an example, battery 118 is illustrated to be supplying power to processor 104. Although not illustrated in the figures, device 100 may comprise a charging circuitry, e.g., to recharge the battery, based on Alternating Current (AC) power supply received from an AC adapter.

In some embodiments, device 100 comprises Power Control Unit (PCU) 110 (also referred to as Power Management Unit (PMU), Power Controller, etc.). In an example, some sections of PCU 110 may be implemented by one or more processing cores 108, and these sections of PCU 110 are symbolically illustrated using a dotted box and labelled PCU 110a. In an example, some other sections of PCU 110 may be implemented outside the processing cores 108, and these sections of PCU 110 are symbolically illustrated using a dotted box and labelled as PCU 110b. PCU 110 may implement various power management operations for device 100. PCU 110 may include hardware interfaces, hardware circuitries, connectors, registers, etc., as well as software components (e.g., drivers, protocol stacks), to implement various power management operations for device 100.

In some embodiments, device 100 comprises Power Management Integrated Circuit (PMIC) 112, e.g., to implement various power management operations for device 100. In some embodiments, PMIC 112 is a Reconfigurable Power Management ICs (RPMICs) and/or an IMVP (Intel® Mobile Voltage Positioning). In an example, the PMIC is within an IC chip separate from processor 104. They may implement various power management operations for device 100. PMIC 112 may include hardware interfaces, hardware circuitries, connectors, registers, etc., as well as software components (e.g., drivers, protocol stacks), to implement various power management operations for device 100.

In an example, device 100 comprises one or both PCU 110 or PMIC 112. In an example, any one of PCU 110 or PMIC 112 may be absent in device 100, and hence, these components are illustrated using dotted lines.

Various power management operations of device 100 may be performed by PCU 110, by PMIC 112, or by a combination of PCU 110 and PMIC 112. For example, PCU 110 and/or PMIC 112 may select a power state (e.g., P-state) and/or C-state for various components of device 100. For example, PCU 110 and/or PMIC 112 may select a power state (e.g., in accordance with the ACPI (Advanced Configuration and Power Interface) specification) for various components of device 100. Merely as an example, PCU 110 and/or PMIC 112 may cause various components of the device 100 to transition to a sleep state, to an active state, to an appropriate C state (e.g., C0 state, or another appropriate C state, in accordance with the ACPI specification), etc. In an example, PCU 110 and/or PMIC 112 may control a voltage output by VR 114 and/or a frequency of a clock signal output by the clock generator, e.g., by outputting the VID signal and/or the FID signal, respectively. In an example, PCU 110 and/or PMIC 112 may control battery power usage, charging of battery 118, and features related to power saving operation.

The clock generator 116 can comprise a phase locked loop (PLL), frequency locked loop (FLL), or any suitable clock source. In some embodiments, each core of processor 104 has its own clock source. As such, each core can operate at a frequency independent of the frequency of operation of the other core. In some embodiments, PCU 110 and/or PMIC 112 performs adaptive or dynamic frequency scaling or adjustment. For example, clock frequency of a processor core can be increased if the core is not operating at its maximum power consumption threshold or limit. In some embodiments, PCU 110 and/or PMIC 112 determines the operating condition of each core of a processor, and opportunistically adjusts frequency and/or power supply voltage of that core without the core clocking source (e.g., PLL of that core) losing lock when the PCU 110 and/or PMIC 112 determines that the core is operating below a target performance level. For example, if a core is drawing current from a power supply rail less than a total current allocated for that core or processor 104, then PCU 110 and/or PMIC 112 can temporality increase the power draw for that core or processor 104 (e.g., by increasing clock frequency and/or power supply voltage level) so that the core or processor 104 can perform at higher performance level. As such, voltage and/or frequency can be increased temporality for processor 104 without violating product reliability.

In an example, PCU 110 and/or PMIC 112 may perform power management operations, e.g., based at least in part on receiving measurements from power measurement circuitries 142, temperature measurement circuitries 140, charge level of battery 118, and/or any other appropriate information that may be used for power management. To that end, PMIC 112 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 110 and/or PMIC 112 in at least one embodiment to allow PCU 110 and/or PMIC 112 to manage processor core energy at least in part based on value(s) detected by one or more of the sensors.

Also illustrated is an example software stack of device 100 (although not all elements of the software stack are illustrated). Merely as an example, processors 104 may execute application programs 150, Operating System 152, one or more Power Management (PM) specific application programs (e.g., generically referred to as PM applications 158), and/or the like. PM applications 158 may also be executed by the PCU 110 and/or PMIC 112. OS 152 may also include one or more PM applications 156a, 156b, 156c. The OS 152 may also include various drivers 154a, 154b, 154c, etc., some of which may be specific for power management purposes. In some embodiments, device 100 may further comprise a Basic Input/output System (BIOS) 120. BIOS 120 may communicate with OS 152 (e.g., via one or more drivers 154), communicate with processors 104, etc.

For example, one or more of PM applications 158, 156, drivers 154, BIOS 120, etc. may be used to implement power management specific tasks, e.g., to control voltage and/or frequency of various components of device 100, to control wake-up state, sleep state, and/or any other appropriate power state of various components of device 100, control battery power usage, charging of the battery 118, features related to power saving operation, etc.

In some embodiments, battery 118 is a Li-metal battery with a pressure chamber to allow uniform pressure on a battery. The pressure chamber is supported by metal plates (such as pressure equalization plate) used to give uniform pressure to the battery. The pressure chamber may include pressured gas, elastic material, spring plate, etc. The outer skin of the pressure chamber is free to bow, restrained at its edges by (metal) skin, but still exerts a uniform pressure on the plate that is compressing the battery cell. The pressure chamber gives uniform pressure to battery, which is used to enable high-energy density battery with, for example, 20% more battery life.

In some embodiments, pCode executing on PCU 110a/b has a capability to enable extra compute and telemetries resources for the runtime support of the pCode. Here pCode refers to a firmware executed by PCU 110a/b to manage performance of the SoC 101. For example, pCode may set frequencies and appropriate voltages for the processor. Part of the pCode are accessible via OS 152. In various embodiments, mechanisms and methods are provided that dynamically change an Energy Performance Preference (EPP) value based on workloads, user behavior, and/or system conditions. There may be a well-defined interface between OS 152 and the pCode. The interface may allow or facilitate the software configuration of several parameters and/or may provide hints to the pCode. As an example, an EPP parameter may inform a pCode algorithm as to whether performance or battery life is more important.

This support may be done as well by the OS 152 by including machine-learning support as part of OS 152 and either tuning the EPP value that the OS hints to the hardware (e.g., various components of SoC 101) by machine-learning prediction, or by delivering the machine-learning prediction to the pCode in a manner similar to that done by a Dynamic Tuning Technology (DTT) driver. In this model, OS 152 may have visibility to the same set of telemetries as are available to a DTT. As a result of a DTT machine-learning hint setting, pCode may tune its internal algorithms to achieve optimal power and performance results following the machine-learning prediction of activation type. The pCode as example may increase the responsibility for the processor utilization change to enable fast response for user activity, or may increase the bias for energy saving either by reducing the responsibility for the processor utilization or by saving more power and increasing the performance lost by tuning the energy saving optimization. This approach may facilitate saving more battery life in case the types of activities enabled lose some performance level over what the system can enable. The pCode may include an algorithm for dynamic EPP that may take the two inputs, one from OS 152 and the other from software such as DTT, and may selectively choose to provide higher performance and/or responsiveness. As part of this method, the pCode may enable in the DTT an option to tune its reaction for the DTT for different types of activity.

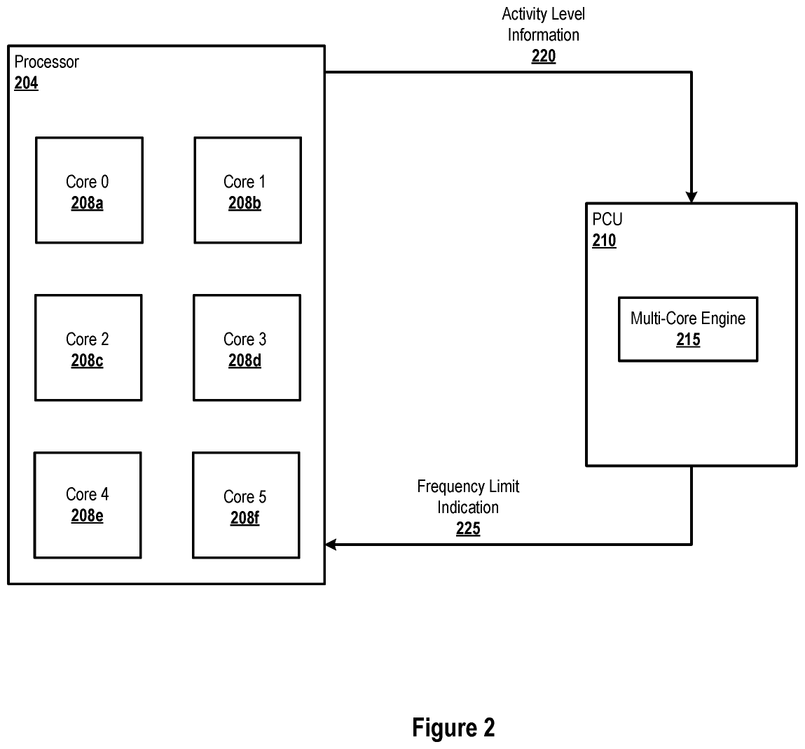

FIG. 2 depicts an example of interaction between a PCU 210 and a multi-core processor 204 of an electronic device, in accordance with various embodiments. The PCU 210 may be similar to one or both of PCUs 110a/110b. The processor 204 may be similar to processor 104. As may be seen in FIG. 2, the processor 204 may have a plurality of cores 208a, 208b, 208c, 208d, 208e, and 208f (referred to collectively as cores 208). It will be noted that embodiments herein may be described with respect to a PCU, however it will be understood that, in some embodiments, some or all of the processes or operations described herein may additionally or alternatively be performed by a PMIC such as PMIC 112.

The PCU 210 may include a multi-core engine 215. Generally, the multi-core engine 215 may be implemented as hardware, firmware, software, and/or some combination thereof. The multi-core engine 215 may be configured to accept as input activity level information 220 related to the activity level of the processor 204 and/or individual activity levels of different ones of cores 208a-208f. The multi-core engine 215 may then, based on the identified activity level(s), identify a frequency limit of the processor 204. The multi-core engine 215 may then output an indication 225 of the frequency limit to the processor 204.

As noted above, various factors may be used to identify the degree to which a core (and, as a result, the overall multi-core processor) 204 may be considered to be “active.” As used herein, the degree of activity may be numerically represented, as referred to as a “weight.” The weights may be identified based on a function or equation. In some embodiments, the function or equation may only relate to a single factor (e.g., there may be separate functions for a voltage-related weight and a temperature-related weight). In some embodiments, a single function may be used to generate a weight related to a plurality of factors (e.g., a function may generate a weight based on both temperature and voltage of a core).

On example function may be as follows:

VoltageWeight=3.75*10⁻⁶e^{10.002*voltage} (Equation 1)

As may be seen, the weight that is related to a voltage of a core may be referred to as “VoltageWeight.” The weight may be based on a function of the voltage being supplied to a given core. Specifically, a core that is active may use more energy (i.e., draw more voltage) than another core that is less active. In this example, if a core was using approximately 0.55 volts (V) (or lower), then the resultant weight may be approximately 0. If a core was using approximately 1.1V, then the resultant weight may be approximately 0.3. If a core was using approximately 1.25 V (or higher), then the resultant weight would be approximately 1.

Another example function may be as follows:

TempWeight=0.0063*e^{0.0552*Temperature} (Equation 2)

As may be seen, the weight that is related to a temperature of a core may be referred to as “TempWeight.” The weight may be based on a function of the temperature of a given core. Specifically, a core may be hotter than another core that is less active. In this example, if a core has a temperature of approximately 90 degrees, then the resultant weight may be approximately 0.9. If a core has a temperature of approximately 85 degrees, then the resultant weight may be approximately 0.7. If a core has a temperature of 50, then the resultant weight may be approximately 0.1.

The resultant weight(s) may then be used, for example by the PCU 210 or the multi-core engine 215 of the PCU 210, to calculate the overall activity level of the core 204. Table 2, below depicts an example of identification of an activity level of the processor 204. Specifically, an example of parameters of cores 208a-208f are depicted in Table 2.

In this example, a weight related to Voltage (referred to as VoltageWeight) and a weight related to Temperature (referred to as TempWeight) are used. These weights may be calculated as described above with respect to Equations 1 and 2.

TABLE 2

| | Core 0 | Core 1 | Core 2 | Core 3 | Core 4 | Core 5 |
|---|---|---|---|---|---|---|
| Voltage | 1.25 | 1.25 | 1.1 | 1.1 | 0.55 | 0.55 |
| Temperature | 90 | 90 | 85 | 85 | 50 | 50 |
| C-State | C0 | C0 | C0 | C0 | C0 | C0 |
| VoltageWeight | 1 | 1 | 0.3 | 0.3 | 0.0 | 0.0 |
| TempWeight | 0.9 | 0.9 | 0.7 | 0.7 | 0.1 | 0.1 |
| TotalWeight | 0.95 | 0.95 | 0.5 | 0.5 | 0.05 | 0.05 |

As may be seen in Table 2, the values for VoltageWeight correspond to Equation 1, above. The values for TempWeight correspond to Equation 2, above. As may be seen, the value for TotalWeight may correspond to an average of the VoltageWeight and TempWeight values.

In one embodiment, the values of TotalWeight from Table 2 may then be summed. The sum of the six TotalWeight values, in this example may be 3, which may indicate an activity level of 3 active cores total. Referring to Table 1, above, then the frequency limit of the processor 204 may be set at 5.1 GHz.

It will be noted that all six of the cores 208a-208f are in the C0 C-state in this example. If using the legacy approach, then the number of identified active cores may be six, which may lead to the processor 204 having a frequency limit of 4.5 GHz according to Table 1. Therefore, it will be recognized that the approach described herein provides benefits of allowing the multi-core processor 204 to run at a higher frequency limit, which may increase the overall efficiency and productivity of the processor 204 without un-necessarily limiting the operation of the processor 204. In other words, the embodiment described herein may increase the performance of the processor 204.

It will be noted that the above-described example is one example of various functions or parameters that may be used. For example, in some embodiments the TotalWeight may be based on a different function such as a mean of the VoltageWeight and TempWeight, a median, a sum of the two factors, a product of the two factors, or some other type of combination. Similarly, the calculation of the total number of active cores of the processor 204 may, in other embodiments, not be based on a sum of the weights; instead the total number of active cores may be based on some other mathematical function such as an average, a mean, a median, a product, some combination thereof, etc.

Additionally, it will be noted that this example may only refer to six different cores 208a-208f, while in other embodiments a processor 204 may include more or fewer cores. Likewise, the values represented in Table 1 may be specific to a particular type of model of processor 204, and other processors 204 (e.g., with a different number of cores, from a different manufacturing facility, from a different company, etc.) may have different frequency limit values corresponding to a number of active cores.

It may also be noted that the particular coefficients used in Equations 1 and 2 may be chosen with respect to a desired outcome. For example, the coefficients from Equations 1 and 2 may be selected to function as a highpass filter such that cores that draw a low amount of power (e.g., less than or equal to approximately 0.55 V) have a VoltageWeight of 0 or approximately 0. Such coefficients may be considered to be biased towards performance of the processor 204. In other words, such coefficients may be selected to attempt to maximize the operating frequency of the processor 204.

In other embodiments, it may be desirable to bias the coefficients and, as a result, the various weights towards increasing the stability of the processor 204. As used herein, a bias towards stability may refer to increasing the life span of a processor such as processor 204. In this embodiment, a voltage of approximately 0.55 V may result in a VoltageWeight of 0.5. A voltage of approximately 0.9 may result in a weight of approximately 0.7. A voltage of approximately 1.25 may result in a weight of approximately 1. As a result, a greater number of active cores may be identified. In accordance with Table 1, a greater number of active cores may result in a lower frequency limit. By lowering the frequency of the processor 204, the overall lifetime of the processor 204 may be extended.

It will further be noted that, in some embodiments the number of active cores that are identified may not be a whole number. For example, the sum of the weights of the cores 208a-208f may be a number such as 3.5, rather than 3. In this embodiment, because the identified number of active cores is between two entries of Table 1, then the resultant frequency limit may be a number that is between two corresponding entries of Table 1. For example, if the number of identified cores is 3.5, then (using the values shown in Table 1, above), the identified frequency limit may be 5.0 GHz. In other words, if the number of identified cores is midway between 3 cores (which may have a frequency limit of 5.1 GHz) and 4 cores (which may have a frequency limit of 4.9 GHz), then the resultant frequency limit may be midway between the values of 5.1 and 4.9 GHz. As another example, if the identified number of cores is 3.3 cores, then the resultant frequency limit may be equal to 4.9+(3*(5.1−4.9)/10)=4.9+3*0.2/10=4.9+3*0.02=4.9+0.06=4.96 GHz. It will be noted that this example is intended as just one example and, in other embodiments, if the number of identified cores is not a whole number, then the resultant frequency limit may be derived in some other way (e.g., rounded up or down to the nearest entry in Table 1).

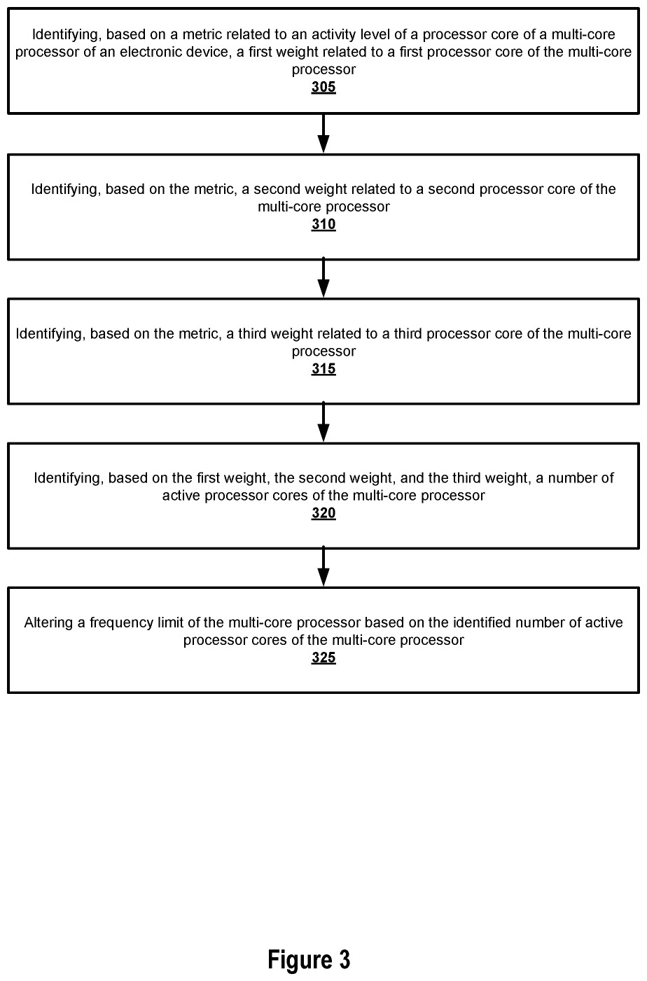

FIG. 3 illustrates an example technique related to determination of a frequency limit of a multi-core processor, in accordance with various embodiments.

While the blocks are illustrated in a particular sequence, the sequence can be modified. For example, some blocks can be performed before others, while some blocks can be performed simultaneously with other blocks. In general, the technique may be performed by PCU 210 and/or the multi-core engine 215 of the PCU 210, while in other embodiments the technique may be performed by additional or alternative elements, processors, logic, etc.

The technique may include identifying, at 305 based on a metric related to an activity level of a processor core of a multi-core processor of an electronic device, a first weight related to a first processor core of the multi-core processor. The metric may be, for example, a metric related to voltage, temperature, frequency, etc. As noted, such metrics may be used in addition to, or instead of, use of the C-state of the core. Using the above-described example, the metric may be related to the temperature or voltage of the core, and the resultant weight may be the TempWeight or VoltageWeight value for a core (e.g., core 208a).

The technique may further include identifying, at 310 based on the metric, a second weight related to a second processor core of the multi-core processor. For example, the weight may be another TempWeight or VoltageWeight for a second core (e.g., core 208c).

The technique may further include identifying, at 315 based on the metric, a third weight related to a third processor core of the multi-core processor. For example, the weight may be another TempWeight or VoltageWeight for a third core (e.g., core 208e). In embodiments, the first weight, second weight, and third weight may be different from one another. For example, as shown in Table 2, the VoltageWeight for core 208a may be 1.0. The VoltageWeight for core 208c may be 0.3. The VoltageWeight for core 208e may be 0.0. As noted, however, these values are intended as example values and other embodiments may include different metrics, different weight values, etc.

The technique may further include identifying, at 320 based on the first weight, the second weight, and the third weight, a number of active processor cores of the multi-core processor. Such identification may be based on some function such as a sum of the weights (as depicted above), or some other function such as a product, an average, a mean, a median, etc.

The technique may further include altering, at 325, a frequency limit of the multi-core processor based on the identified number of active processor cores of the multi-core processor. For example, such alteration may include identifying, based on the number of active cores, a corresponding frequency limit of the processor 204 using a table such as Table 1 or some other table. The PCU 210 and/or the multi-core engine 215 may then output a frequency limit indication 225 to the processor 204 that may be used by the processor 204 to alter the frequency limit of the processor 204.

The flowchart of FIG. 3 can be performed partially or wholly by software providing in a machine-readable storage medium (e.g., memory such as memory 130). The software is stored as computer-executable instructions (e.g., instructions to implement any other processes discussed herein). Program software code/instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, the program software code/instructions associated with flowchart (and/or various embodiments) are executed by the processor system.

In some embodiments, the program software code/instructions associated with the flowchart (and/or various embodiments) are stored in a computer executable storage medium and executed by the processor 104, the PCU 110a or 110b, and/or the PMIC 112. Here, the computer executable storage medium is a tangible machine readable medium that can be used to store program software code/instructions and data that, when executed by a computing device, causes one or more processors to perform a method(s) as may be recited in one or more accompanying claims directed to the disclosed subject matter.

The tangible machine-readable medium may include storage of the executable software program code/instructions and data in various tangible locations, including for example ROM, volatile RAM, non-volatile memory and/or cache and/or other tangible memory as referenced in the present application. Portions of this program software code/instructions and/or data may be stored in any one of these storage and memory devices. Further, the program software code/instructions can be obtained from other storage, including, e.g., through centralized servers or peer to peer networks and the like, including the Internet. Different portions of the software program code/instructions and data can be obtained at different times and in different communication sessions or in the same communication session.

The software program code/instructions (associated with the flowchart and other embodiments) and data can be obtained in their entirety prior to the execution of a respective software program or application by the computing device. Alternatively, portions of the software program code/instructions and data can be obtained dynamically, e.g., just in time, when needed for execution. Alternatively, some combination of these ways of obtaining the software program code/instructions and data may occur, e.g., for different applications, components, programs, objects, modules, routines or other sequences of instructions or organization of sequences of instructions, by way of example. Thus, it is not required that the data and instructions be on a tangible machine readable medium in entirety at a particular instance of time.

Examples of the tangible computer-readable media include but are not limited to recordable and non-recordable type media such as volatile and non-volatile memory devices, read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs), etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, tangible machine readable medium includes any tangible mechanism that provides (e.g., stores and/or transmits in digital form, e.g., data packets) information in a form accessible by a machine (e.g., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Galaxy®, Blackberry® Droid®, or the like, or any other device including a computing device. In one embodiment, processor-based system is in a form of or included within a PDA (personal digital assistant), a cellular phone, a notebook computer, a tablet, a game console, a set top box, an embedded system, a TV (television), a personal desktop computer, etc. Alternatively, the traditional communication applications and subsidized application(s) may be used in some embodiments of the disclosed subject matter.

Some non-limiting Examples of various embodiments are presented below.

Example 1 includes one or more non-transitory computer-readable media comprising instructions that, when executed, are to cause a power control unit (PCU) of an electronic device to: identify, based on a metric related to an activity level of a processor core of a multi-core processor of the electronic device, a first weight related to a first processor core of the multi-core processor; identify, based on the metric, a second weight related to a second processor core of the multi-core processor; identify, based on the metric, a third weight related to a third processor core of the multi-core processor, wherein the first weight, second weight, and third weight are different from one another; identify, based on the first weight, the second weight, and the third weight, a number of active processor cores of the multi-core processor; and alter a frequency limit of the multi-core processor based on the identified number of active processor cores of the multi-core processor.

Example 2 includes the one or more non-transitory computer-readable media of example 1, and/or some other example herein, wherein the metric is related to a voltage of the processor core.

Example 3 includes the one or more non-transitory computer-readable media of any of examples 1-3, and/or some other example herein, wherein the metric is related to a temperature of the processor core.

Example 4 includes the one or more non-transitory computer-readable media of any of examples 1-3, and/or some other example herein, wherein the metric is related to a frequency of the processor core.

Example 5 includes the one or more non-transitory computer-readable media of any of examples 1-4, and/or some other example herein, wherein the metric is un-related to an activity state of the processor core.

Example 6 includes the one or more non-transitory computer-readable media of any of examples 1-5, and/or some other example herein, wherein the identified frequency limit is based on correlation of the identified number of active cores with a plurality of pre-identified frequency limits and a plurality of pre-identified numbers of active processor cores, wherein respective frequency limits of the plurality of pre-identified frequency limits are related to a respective number of active processor cores of the plurality of pre-identified numbers of active processor cores.

Example 7 includes the one or more non-transitory computer-readable media of example 6, and/or some other example herein, wherein the identified frequency limit is based on identification that the identified number of active cores is between two of the plurality of pre-identified numbers of active processor cores.

Example 8 includes the one or more non-transitory computer-readable media of example 7, and/or some other example herein, wherein the identified frequency limit is between two of the plurality of pre-identified frequency limits.

Example 9 includes an electronic device comprising: a multi-core processor that includes a plurality of processor cores; and a power control unit (PCU) coupled with the multi-core processor, wherein the PCU is configured to: identify, based on a metric related to an activity level of a processor core of the plurality of processor cores, a first weight related to a first processor core of the plurality of processor cores; identify, based on the metric, a second weight related to a second processor core of the plurality of processor cores; identify, based on the metric, a third weight related to a third processor core of the plurality of processor cores, wherein the first weight, second weight, and third weight are different from one another; identify, based on the first weight, the second weight, and the third weight, a number of active processor cores of the plurality of processor cores; and alter a frequency limit of the multi-core processor based on the identified number of active processor cores of the plurality of processor cores.

Example 10 includes the electronic device of example 9, and/or some other example herein, wherein the metric is related to a voltage of the processor core.

Example 11 includes the electronic device of any of examples 9-10, and/or some other example herein, wherein the metric is related to a temperature of the processor core.

Example 12 includes the electronic device of any of examples 9-11, and/or some other example herein, wherein the metric is related to a frequency of the processor core.

Example 13 includes the electronic device of any of examples 9-12, and/or some other example herein, wherein the metric is un-related to an activity state of the processor core.

Example 14 includes the electronic device of any of examples 9-13, and/or some other example herein, wherein the identified frequency limit is based on correlation of the identified number of active cores with a plurality of pre-identified frequency limits and a plurality of pre-identified numbers of active processor cores, wherein respective frequency limits of the plurality of pre-identified frequency limits are related to a respective number of active processor cores of the plurality of pre-identified numbers of active processor cores.

Example 15 includes the electronic device of example 14, wherein the identified frequency limit is based on identification that the identified number of active cores is between two of the plurality of pre-identified numbers of active processor cores.

Example 16 includes the electronic device of example 15, and/or some other example herein, wherein the identified frequency limit is between two of the plurality of pre-identified frequency limits.

Example 17 includes a power control unit (PCU) configured for use with an electronic device, wherein the PCU comprises: circuitry to communicatively coupled with a multi-core processor; and logic configured to: identify, based on a metric related to an activity level of a processor core of the multi-core processor of the electronic device, a first weight related to a first processor core of the multi-core processor; identify, based on the metric, a second weight related to a second processor core of the multi-core processor; identify, based on the metric, a third weight related to a third processor core of the multi-core processor, wherein the first weight, second weight, and third weight are different from one another; identify, based on the first weight, the second weight, and the third weight, a number of active processor cores of the multi-core processor; and alter a frequency limit of the multi-core processor based on the identified number of active processor cores of the multi-core processor.

Example 18 includes the PCU of example 17, and/or some other example herein, wherein the metric is related to a voltage of the processor core.

Example 19 includes the PCU of any of examples 17-18, and/or some other example herein, wherein the metric is related to a temperature of the processor core.

Example 20 includes the PCU of any of examples 17-19, and/or some other example herein, wherein the metric is related to a frequency of the processor core.

Example 21 includes the PCU of any of examples 17-20, and/or some other example herein, wherein the metric is un-related to an activity state of the processor core.

Example 22 includes the PCU of any of examples 17-21, and/or some other example herein, wherein the identified frequency limit is based on correlation of the identified number of active cores with a plurality of pre-identified frequency limits and a plurality of pre-identified numbers of active processor cores, wherein respective frequency limits of the plurality of pre-identified frequency limits are related to a respective number of active processor cores of the plurality of pre-identified numbers of active processor cores.

Example 23 includes the PCU of example 22, and/or some other example herein, wherein the identified frequency limit is based on identification that the identified number of active cores is between two of the plurality of pre-identified numbers of active processor cores.

Example 24 includes the PCU of example 23, and/or some other example herein, wherein the identified frequency limit is between two of the plurality of pre-identified frequency limits.

In the preceding detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting. Specifically, while the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1. One or more non-transitory computer-readable media comprising instructions that, when executed, are to cause a power control unit (PCU) of an electronic device to:
identify, based on a metric related to an activity level of a processor core of a multi-core processor of the electronic device, a first weight related to a first processor core of the multi-core processor;
identify, based on the metric, a second weight related to a second processor core of the multi-core processor;
identify, based on the metric, a third weight related to a third processor core of the multi-core processor, wherein the first weight, second weight, and third weight are different from one another;
identify, based on the first weight, the second weight, and the third weight, a number of active processor cores of the multi-core processor; and
alter a frequency limit of the multi-core processor based on the identified number of active processor cores of the multi-core processor.

2. The one or more non-transitory computer-readable media of claim 1, wherein the metric is related to a voltage of the processor core.

3. The one or more non-transitory computer-readable media of claim 1, wherein the metric is related to a temperature of the processor core.

4. The one or more non-transitory computer-readable media of claim 1, wherein the metric is related to a frequency of the processor core.

5. The one or more non-transitory computer-readable media of claim 1, wherein the metric is un-related to an activity state of the processor core.

6. The one or more non-transitory computer-readable media of claim 1, wherein the identified frequency limit is based on correlation of the identified number of active cores with a plurality of pre-identified frequency limits and a plurality of pre-identified numbers of active processor cores, wherein respective frequency limits of the plurality of pre-identified frequency limits are related to a respective number of active processor cores of the plurality of pre-identified numbers of active processor cores.

7. An electronic device comprising:
a multi-core processor that includes a plurality of processor cores; and
a power control unit (PCU) coupled with the multi-core processor, wherein the PCU is configured to:
identify, based on a metric related to an activity level of a processor core of the plurality of processor cores, a first weight related to a first processor core of the plurality of processor cores;
identify, based on the metric, a second weight related to a second processor core of the plurality of processor cores;
identify, based on the metric, a third weight related to a third processor core of the plurality of processor cores, wherein the first weight, second weight, and third weight are different from one another;
identify, based on the first weight, the second weight, and the third weight, a number of active processor cores of the plurality of processor cores; and
alter a frequency limit of the multi-core processor based on the identified number of active processor cores of the plurality of processor cores.

8. The electronic device of claim 7, wherein the metric is related to a voltage of the processor core.

9. The electronic device of claim 7, wherein the metric is related to a temperature of the processor core.

10. The electronic device of claim 7, wherein the metric is related to a frequency of the processor core.

11. The electronic device of claim 7, wherein the metric is un-related to an activity state of the processor core.

12. The electronic device of claim 7, wherein the identified frequency limit is based on correlation of the identified number of active cores with a plurality of pre-identified frequency limits and a plurality of pre-identified numbers of active processor cores, wherein respective frequency limits of the plurality of pre-identified frequency limits are related to a respective number of active processor cores of the plurality of pre-identified numbers of active processor cores.

13. A power control unit (PCU) configured for use with an electronic device, wherein the PCU comprises:
circuitry to communicatively coupled with a multi-core processor; and
logic configured to:
identify, based on a metric related to an activity level of a processor core of the multi-core processor of the electronic device, a first weight related to a first processor core of the multi-core processor;
identify, based on the metric, a second weight related to a second processor core of the multi-core processor;
identify, based on the metric, a third weight related to a third processor core of the multi-core processor, wherein the first weight, second weight, and third weight are different from one another;
identify, based on the first weight, the second weight, and the third weight, a number of active processor cores of the multi-core processor; and
alter a frequency limit of the multi-core processor based on the identified number of active processor cores of the multi-core processor.

14. The PCU of claim 13, wherein the metric is related to a voltage of the processor core.

15. The PCU of claim 13, wherein the metric is related to a temperature of the processor core.

16. The PCU of claim 13, wherein the metric is related to a frequency of the processor core.

17. The PCU of claim 13, wherein the metric is un-related to an activity state of the processor core.

18. The PCU of claim 13, wherein the identified frequency limit is based on correlation of the identified number of active cores with a plurality of pre-identified frequency limits and a plurality of pre-identified numbers of active processor cores, wherein respective frequency limits of the plurality of pre-identified frequency limits are related to a respective number of active processor cores of the plurality of pre-identified numbers of active processor cores.

19. The PCU of claim 18, wherein the identified frequency limit is based on identification that the identified number of active cores is between two of the plurality of pre-identified numbers of active processor cores.

20. The PCU of claim 19, wherein the identified frequency limit is between two of the plurality of pre-identified frequency limits.
